(19) United States
(12) Patent Application Publication
(10) Pub. No.: US 2006/0102126 A1
(43) Pub. Date: May 18, 2006

(54) Automatic fuel enrichment for an engine

(75) Inventors: Hiroshi Nakata, Shibata-Gun (JP); Makoto Waku, Kurokawa-Gun (JP)

Correspondence Address: REISING, ETHINGTON, BARNES, KISSELLE, P.C., P O BOX 4390, TROY, MI, 48099-4390, US

(73) Assignee: Walbro Engine Management, L.L.C.

(21) Appl. No.: 11/274,086

(22) Filed: Nov. 15, 2005

(30) Foreign Application Priority Data
Nov. 18, 2004 (JP) 2004-334842
Oct. 14, 2005 (JP) 2005-299572

(51) Int. Cl. F02M 1/12

(52) U.S. Cl. 123/179.15

(57) ABSTRACT

A method and system for preventing excessive fuel supply during engine startup, including supplying supplementary fuel during cranking of a cold engine and preventing supply of the supplementary fuel if the engine fails to start running. A solenoid valve in a supplementary fuel supply passage permits the supply of supplementary fuel. A switching device controls the solenoid valve and is grounded by a thermistor that is placed adjacent to a heater element. During cranking, electric current is supplied to the heater element, which progressively increases in temperature to cause the electric resistance of the adjacent thermistor to decrease over a predetermined time, thereby causing the transistor to turn off and deactivate the solenoid valve. Thus, if the engine fails to start within the predetermined time, the supplementary fuel supply is cut off by the solenoid valve, thereby reducing the possibility of excessive fuel enrichment and engine flooding.

### CROSS-REFERENCE TO RELATED APPLICATION

Applicants claim priority of Japanese Application, Ser. No. 2004-334842, filed Nov. 18, 2004, and Japanese Application, Ser. No. 2005-299572, filed Oct. 14, 2005.

### FIELD OF THE INVENTION

The present invention relates generally to fuel delivery in internal combustion engines, and more particularly to automatic fuel enrichment for starting an engine.

### BACKGROUND OF THE INVENTION

A carburetor of an internal combustion engine is known to have a fuel-and-air mixing passage for delivering a controlled ratio of fuel-and-air to a combustion chamber of the engine. The fuel-and-air mixing passage is carried by a body of the carburetor and has a choke valve disposed therein to generally control or limit an amount of air flowing through the mixing passage. Liquid hydrocarbon fuel flows from a fuel chamber of the carburetor, through a primary fuel supply passage in the carburetor body, and into the mixing passage.

The typical fuel-to-air ratio of a hot, running engine is generally less than the fuel-to-air ratio necessary to reliably start a cold engine. To adjust the fuel-to-air ratio, the choke valve is typically used to limit the air flow rate through the mixing passage relative to the fuel flow rate. For example, prior to starting a cold engine an operator manually places the choke valve in a substantially closed or “choke-on” position. Accordingly, the choke valve blocks or “chokes” air flow through the fuel-and-air mixing passage to such an extent that pulsating vacuum induced by reciprocating pistons in the engine will be higher than normal in the mixing passage and, thus, will pull an extra quantity of fuel from the fuel chamber into the mixing passage and the combustion chamber. Accordingly, a rich or fuel-rich mixture of fuel-and-air flows through the mixing passage and into the combustion chamber of the engine.

In addition, some carburetors are known to have startup systems for a carburetor that provide an additional amount of fuel when cranking a cold engine by opening a “start fuel” supply passage provided separately from the primary fuel supply passage, and that stop the supply of the start fuel once the engine has been successfully started. In some cases, however, the engine may fail to start quickly and, because the supplementary fuel supply passage remains open, the start fuel continues to be supplied to the engine, thereby “flooding” a spark plug in the combustion chamber of the engine with an excessively rich mixture of fuel-and-air. Once the spark plug becomes flooded, the engine is difficult or impossible to start, and the operator must wait until the fuel evaporates from the spark plug before trying to start the engine again.

In a specific example according to Japanese Utility Model Application No. 1-96630, a system includes a thermistor for detecting the temperature of an engine as well as a sensor for detecting a rotational speed of the engine, and a reference value of the engine speed is defined in relation to the detected engine temperature. Accordingly, an added amount of start fuel is supplied to the engine by opening a supplementary fuel supply passage when the engine speed at engine start up is below the reference value, and the added amount of start fuel is not supplied to the engine by closing the supplementary fuel supply passage when the engine speed is above the reference value. In other words, engine start up fuel is controlled according to the engine speed and temperature. With this system, however, if the engine fails to quickly start, the engine remains cold and the start fuel continues to be supplied, thereby flooding the engine spark plug and rendering the engine very difficult to start without a significant delay.

### SUMMARY OF THE INVENTION

The invention is generally directed to a method and system for automatically enriching a fuel-and-air supply from a carburetor to an engine by supplying a supplementary amount of fuel when cranking the engine, but preventing the supplementary amount of fuel from continuing to be supplied when the engine fails to start.

The system is provided for a carburetor to supply a supplementary amount of fuel when starting a cold engine, as compared to an amount of fuel that normally would be supplied through a primary fuel supply passage when the engine is hot and operating normally. The system includes a supplementary fuel supply passage provided separately from the primary fuel supply passage, a solenoid valve for opening and closing the supplementary fuel supply passage, and one or more engine sensors including a speed sensor for detecting a rotational speed of the engine, and/or a temperature sensor for detecting a temperature of the engine.

The system further includes a switching device connected in series with the solenoid valve for controlling the solenoid valve, a control circuit that turns on and off the switching device in dependence on the engine temperature and/or speed detected by the engine sensor(s), a resistive heater element connected in parallel with the solenoid valve and switching device, and a thermistor placed adjacent to the resistive heater element and connected to a control line of the switching device so as to draw current from the control line to turn off the switching device when the resistive heater element rises in temperature beyond a prescribed level.

According to the method, if the engine temperature is low when cranking the engine, the solenoid valve is opened by turning on the switching device and a supplementary amount of fuel is supplied to the engine so that the engine may be started with the benefit of a rich fuel-and-air mixture when the engine is cold. If the engine temperature is high, for example because the engine was in operation until a short time before the engine is cranked or for other reasons, the solenoid valve is closed by turning off the switching device to stop further supply of fuel for starting the engine so that an excessive amount of fuel is prevented from being supplied to the warm engine.

When the engine is initially cranked in a cold state, the solenoid valve opens and the electric resistance of the thermistor progressively decreases with time as the resistive heater element increasingly produces heat. Because the thermistor is adapted to draw the electric current supplied to the control line of the switching device away from the switching device, the decreasing electric resistance of the thermistor eventually turns the switching device non-conductive. Therefore, upon initial cranking when the engine fails to start, the switching device becomes non-conductive and the solenoid valve closes upon elapsing of a certain period of time corresponding to the generation of a prescribed amount of heat so that any further supply of supplementary fuel for starting the engine is discontinued. Accordingly, an excessive amount of fuel is not supplied to the engine when the engine fails to start, so that flooding of an engine spark plug can be avoided and the possibility of successfully starting the engine by subsequent engine cranking is increased.

At least some of the objects, features and advantages that may be achieved by at least certain embodiments of the invention include providing a method and system that supplies supplementary fuel to an engine by automatically initiating supplementary fuel supply during engine startup and automatically ceasing supplementary fuel supply after the engine has successfully started, avoids an excessively rich fuel-to-air mixture and concomitant engine flooding during startup, provides engine control circuitry that also serves as ignition control circuitry, integrates control circuitry, a resistive heater element, and a thermistor into a module, is of relatively simple design and economical manufacture and assembly, durable, reliable and in service has a long useful life.

Of course, other objects, features and advantages will be apparent in view of this disclosure to those skilled in the art. Other methods and systems embodying the invention may achieve more or less than the noted objects, features or advantages.

### BRIEF DESCRIPTION OF THE DRAWINGS

These and other objects, features and advantages of the present invention will be apparent from the following detailed description of the preferred embodiment and best mode, appended claims, and accompanying drawings in which:

FIG. 1 is a schematic diagram of an exemplary form of an automatic fuel enrichment system for use with an internal combustion engine including a carburetor;

FIG. 2 is a schematic diagram of an exemplary engine control circuit of the system of FIG. 1;

FIG. 3 is a flowchart showing an exemplary method of starting an internal combustion engine;

FIG. 4 is a schematic diagram of another exemplary form of an automatic fuel enrichment system;

FIG. 5 is a schematic diagram of an exemplary engine control circuit of the system of FIG. 4;

FIG. 6 is a schematic diagram of another exemplary engine control circuit of the system of FIG. 4; and

FIG. 7 is a schematic diagram of a modification of the exemplary engine control circuit of FIG. 6.

### DETAILED DESCRIPTION OF THE PREFERRED EMBODIMENT

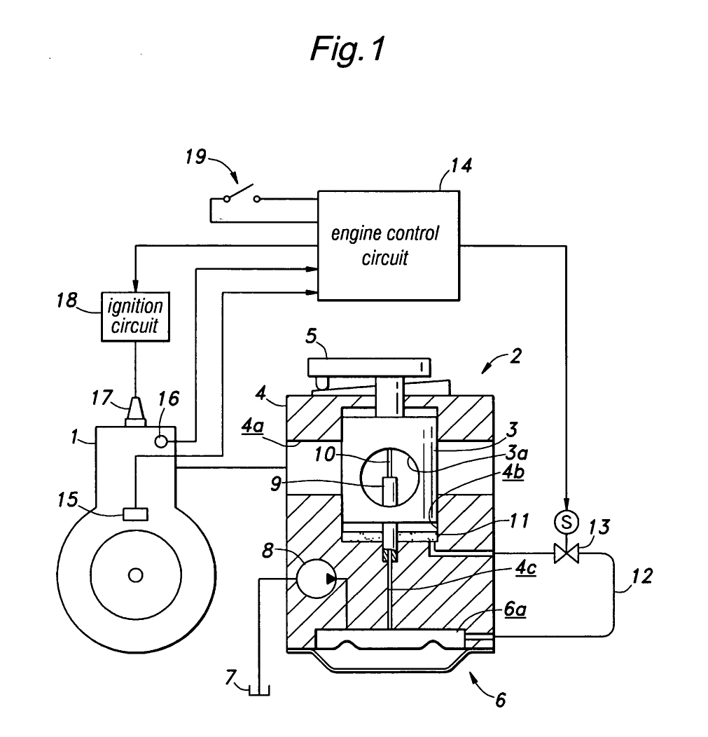

Referring in more detail to the drawings, FIG. 1 illustrates an automatic fuel enrichment starter system of a small internal combustion engine 1. The engine 1 receives a necessary amount of fuel-and-air mixture from a carburetor 2 connected to an intake port of the engine 1. The carburetor 2 of the illustrated embodiment uses a cylindrical rotary valve 3, but is not required to be a carburetor of this type. The rotary valve 3 may represent a throttle valve, a choke valve, or a combined choke and throttle valve. Other types of carburetors may be used, such as a butterfly valve and float bowl carburetor.

The carburetor 2 has an intake passage or bore 4a that extends across of a main body 4 of the carburetor 2, and the rotary valve 3 is disposed in the intake bore 4a so as to extend perpendicularly across the intake bore 4a. The rotary valve 3 is received in a cylindrical valve recess 4b formed in the main body 4 so as to be rotatable around an axial line extending perpendicularly across the intake bore 4a and movable along the axial line. The rotary valve 3 is provided with a mixture passage 3a that extends perpendicularly with respect to the rotary axis of the valve so that the degree of communication between the intake bore 4a and mixture passage 3a may be varied depending on the rotational angle of the rotary valve 3.

A rotary valve shaft is coaxially and integrally formed with the rotary valve 3 and extends out of the main body 4, and a lever 5 is attached to the projecting end of the rotary valve shaft. Typically, a throttle wire (not shown in the drawings) is connected to the lever 5, and the rotary valve 3 turns as the lever 5 turns. The lever 5 has a camming engagement with the opposing end surface of the main body 4 so that the lever moves axially as it is turned, and this in turn causes an axial movement of the rotary valve 3.

A bottom part of the main body 4 accommodates a diaphragm type fuel adjusting or metering mechanism 6 to which fuel is supplied by a diaphragm type fuel pump 8 that draws fuel from an external fuel tank and feeds the fuel into a fuel chamber 6a of the fuel adjusting mechanism 6 and defined in part by a diaphragm. The fuel pump 8 is powered by pulsating pressure in a crankcase chamber of the engine 1. The fuel chamber 6a of the fuel adjusting mechanism 6 communicates with a fuel nozzle 9 that is coaxial with the rotary valve 3 and projects into the mixture supply passage 3a.

A primary fuel supply to the intake passage 4a is formed by a primary fuel passage 4c extending from the fuel chamber 6a to the fuel nozzle 9 and by the fuel nozzle 9 itself. A needle valve 10 for fuel adjustment projects coaxially from the wall of the mixture supply passage 3a opposite to the fuel nozzle 9, and extends into the fuel nozzle 9. As the needle valve 10 moves axially into and out of the fuel nozzle 9 because of the axial movement of the rotary valve 3, the opening area of a fuel ejection or discharge orifice in the peripheral wall of the fuel nozzle 9 changes so that the amount of fuel ejected or discharged may be controlled according to the opening area of the rotary valve 3.

The carburetor 2 is further provided with a mechanism for supplying an added or supplementary amount of fuel (i.e. start fuel) for starting the engine. A fuel reservoir 11 includes a ceramic or other porous material interposed between the lower surface of the rotary valve 3 and the bottom of the rotary valve recess 4b. The fuel reservoir 111 communicates with the fuel chamber 6a via a supplementary fuel supply passage 12 that is provided with a solenoid valve 13 in communication therewith. The solenoid valve 13 is controlled by an engine control circuit 14 which may be connected to one or both of a rotational speed sensor 15 for detecting the rotational speed of the engine 1 or a temperature sensor 16 for detecting the temperature of the engine 1. The engine control circuit 14 may also be connected to an ignition circuit 18 for providing electric current to a spark plug 17, and a start switch 19, which may be used with an automatic electric starter motor or may be used with a manual starter such as a recoil starter.

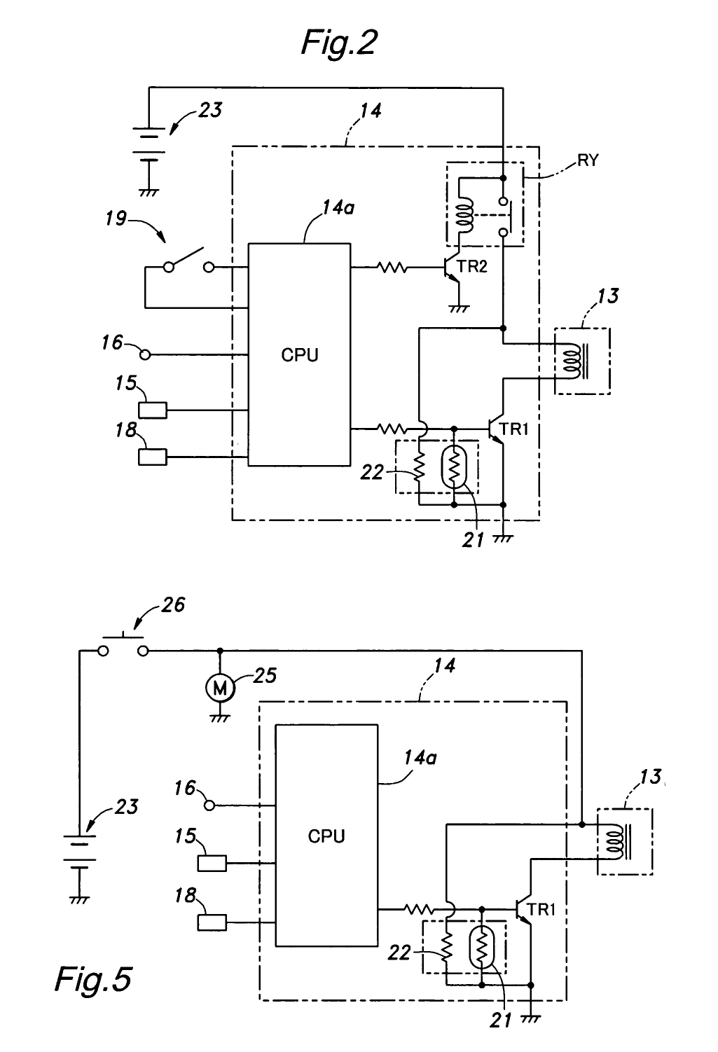

Referring to FIG. 2, a power source 23 such as a battery is used for storing and supplying electrical current to power the engine control circuit 14. More specifically, the battery 23 preferably powers the solenoid valve 13, a switching device RY such as a relay, and a heater element 22. In automatic starter configurations, the battery 23 may also be connected to an electric starter motor (not shown) for powering the starter motor.

In either automatic starter or manual starter configurations, the engine control circuit 14 includes a processor or central processing unit (CPU) 14a that executes control logic according to a program and the relay RY has a normally open contact set interposed between the battery 23 and one end of a solenoid or coil of the solenoid valve 13. The other end of the coil of the solenoid valve 13 is connected to a collector of a switching device TR1, such as a transistor, having an emitter that is grounded. The coil of the relay RY is energized and de-energized by another switching device TR2, such as a transistor, which is in turn turned on and off by the CPU 14a. Although transistors are disclosed as exemplary switching devices herein, it is contemplated that any suitable switching devices may be used.

The control line that leads from the CPU 14a to the base of the transistor TR1 is grounded via a thermistor 21. Adjacent to the thermistor 21 is provided a resistive heater element 22, which is connected in parallel with the coil of the solenoid valve 13 and the transistor TR1. The thermistor 21 and resistive heater element 22 may be integrated with the engine control circuit 14 as a single module if desired.

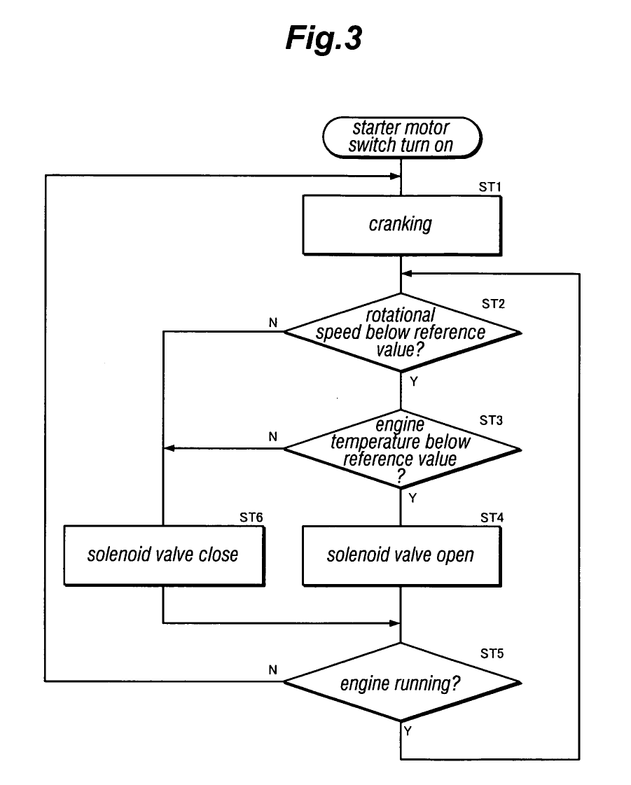

FIG. 3 illustrates a method of operation of the above described system during engine startup, wherein a fuel-and-air supply from a carburetor to an engine is automatically enriched. As represented by step ST1, the start switch 19 is turned on to enable cranking of the engine 1, such as by using an electric starter motor (not shown), or a manual recoil starter. Preferably, as shown in FIG. 2, the engine control circuitry 14 integrates the ignition control functions therein such that cranking of the engine 1 is carried out substantially simultaneously as the ignition circuit 18 controls ignition timing. Accordingly, the engine control circuitry 14 is preferably combined with ignition control circuitry 18 into a single unit to avoid the inconvenience of providing separate circuitry.

In any event, the CPU 14a forwards an ignition signal to the ignition circuit 18 according to ignition timing based on the engine rotational signal obtained by the rotational sensor 15 for cranking the engine 1. Using the ignition signal as a trigger signal, the CPU 14a turns on the transistor TR2. This in turn causes the relay RY to be energized by applying voltage from the battery 23 to the coil of the relay RY, thereby causing the normally open contact set of the relay RY to close. If the transistor TR1 is non-conductive, the coil of the solenoid valve 13 is not energized, and the solenoid valve 13 remains closed.

As shown by step ST2, once the engine 1 has started turning, the rotational speed of the engine 1 is detected by the rotational speed sensor 15, and it is then determined if the detected rotational speed of the engine 1 is below or less than a reference value, or if it is greater than or equal to the reference value. This reference value may correspond to a rotational speed slightly below the normal idling rotational speed. If the engine rotational speed is below the reference value in step ST2, the program flow advances to step ST3.

In step ST3, it is determined if the engine temperature detected by the temperature sensor 16 is below or less than a reference value, or if it is greater than or equal to the reference value. The reference value may be selected such as to allow a determination by the processor 14a whether the engine 1 is cold, such as when it has not been operated for a prolonged period of time, or if the engine 1 is warm, such as when the engine 1 was operating until a short time ago. For instance, the reference value may correspond to a temperature slightly below the temperature of the outer wall of the engine 1 at the time of idling. If the engine temperature is below this reference value in step ST3, the program flow advances to step ST4.

In step ST4, according to certain conditions, such as low rotational speed and/or low temperature, that led the program flow to this step, the CPU 14a feeds an ON signal to the transistor TR1 to produce a state that suits the cranking of the engine 1 under this condition(s). More specifically, the ground end of the coil of the solenoid valve 13 is grounded when the transistor TR1 is ON so as to energize the coil and thereby open the solenoid valve 13. Opening of the solenoid valve 13 opens the supplementary fuel supply passage 12 so that fuel from the fuel chamber 6a is allowed to flow into the fuel reservoir 11. The fuel in the fuel reservoir 11 is then drawn into the intake bore 4a via a gap defined between the outer circumferential surface of the rotary valve 3 and the inner circumferential surface of the rotary valve recess 4b. Instead of this gap, a separate passage could be provided between the fuel reservoir and the intake bore 4a. By thus supplying an added amount of fuel at the time of starting the engine, it becomes possible to readily start the engine 1 when it is cold.

In step ST5, it is determined if the engine 1 is running or not, such as by determining if the engine 1 is stationary or not, or rotating at or above a reference value, or the like, preferably according to output from the rotational speed sensor 15.

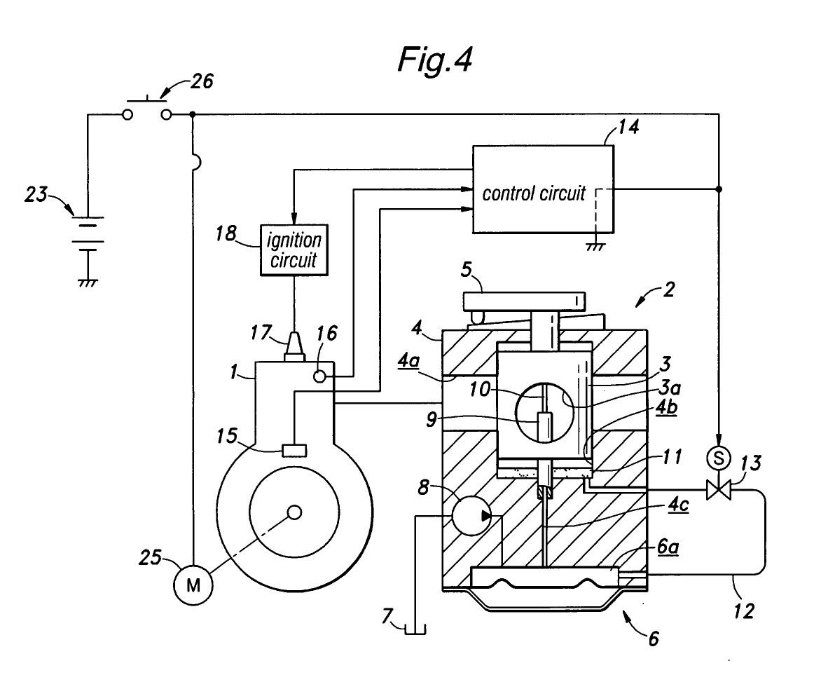

If, at step ST5, the engine 1 is not running, or is not running at or above a reference value, the program flow returns to step ST1, and cranking of the engine 1 may be resumed. If, in the case of an apparatus having an electric starter motor with an electric starter motor switch 26 (e.g. FIGS. 4 and 5), the engine 1 has already been running for some period of time but has ceased running, then at step ST1 an operator would again activate the electric starter motor switch 26.

If, however at step ST5, the engine 1 is running, or is running at or above a reference value, the program flow returns to step ST2.

If the engine speed is determined to be higher than the reference value in step ST2 or if the engine temperature is determined to be higher than the reference value in step ST3, then the program flow advances to step ST6. When rotational speed is at or above a reference value and/or engine temperature is at or above a reference value, then there is no need to supply the supplementary amount of fuel and, accordingly, the CPU 14a feeds an OFF signal to the transistor TR1 so that the solenoid valve 13 is de-energized and the solenoid valve 13 thus closes.

As a result, the communication between the fuel chamber 6a and fuel reservoir 11 via the supplementary fuel supply passage 12 is cut off so that fuel from the fuel reservoir 11 is not drawn into the intake bore 4a and only the normal or primary amount of fuel is ejected from the fuel nozzle 9. Advantageously, the solenoid valve 13 is closed immediately after the engine 1 has successfully started so that excessive enrichment or choking of the engine 1, and resulting flooding thereof, may be effectively avoided.

Also, the closing of the contact set of the relay RY causes electric current to be supplied to the resistive heater element 22 connected to the node between the contact set of the relay RY and the coil of the solenoid valve 13 so that the resistive heater element 22 produces heat. The quantity of produced heat progressively increases with time and, because the thermistor 21 is placed adjacent to this resistive heater element 22, the resistance of the thermistor 21 progressively decreases as it is heated by the resistive heater element 22.

The engine 1 may ultimately fail to start when cranked with the solenoid valve 13 open under a low rotational speed and low temperature condition, wherein steps ST1 to ST5 repeat as long as the engine 1 is not running. When such conditions persist, the supplementary supply of fuel may ordinarily flood the spark plug 17 of the engine 1, and could prevent or make difficult the starting of the engine 1.

However, the resistive heater element 22 starts producing heat as soon as engine cranking begins (i.e. when the start switch 19 is turned on), and the produced heat eventually reduces the electric resistance of the thermistor 21 to such an extent that electric current is diverted through the thermistor 21 away from the base of the transistor TR1, which eventually becomes non-conductive. As a result, the solenoid valve 13 closes and any further supply of the supplementary amount of fuel ceases. Therefore, if the engine 1 does not start until the time the solenoid valve 13 closes, according to the decrease of the electric resistance of the thermistor 21, then the supply of the supplementary amount of fuel is discontinued without regard to the control flow shown in FIG. 3.

If the start switch 19 is repeatedly or kept turned on, such as during cranking of the engine 1, the electric current continues to flow through the resistive heater element 22, and the transistor TR1 continues to be non-conductive because of the heated thermistor 21. In cases where the engine 1 fails to start, the engine operator may turn off, or stop pressing, the start switch 19. This allows the resistive heater element 22 to cool, thereby allowing the thermistor 21 to cool and return to the state where it ceases to draw the base current away from the transistor TR1. Thereafter, when the start switch 19 is turned on once again, the engine 1 may be cranked and, if the engine is cold, provided with the benefit of the supply of the supplementary amount of start fuel.

The time period that it takes for the thermistor 21 to draw the base current and turn the transistor TR1 non-conductive may be selected so as to be shorter than the time period that it takes for the spark plug 17 to be flooded. The time period may be selected by suitably selecting the resistive properties of the resistive heater element 22. Also, because it takes some time for the thermistor 21 to cool off and regain its normal state, when the engine 1 has failed to start, unnecessary opening of the solenoid valve 13 and excessive enrichment or choking of the engine 1 is avoided.

The time period during which the supplementary amount of start fuel is required to be supplied varies depending on the surrounding or ambient temperature. Preferably, the start fuel is required to be supplied for a relatively longer period of time when the surrounding temperature is low, and for a relatively shorter period of time when the surrounding temperature is high. The time period that it takes for the transistor TR1 to turn off is determined by the influence of the heat produced from the resistive heater element 22 on the thermistor 21. The intensity of heat transfer to the thermistor 21 depends on the surrounding temperature in such a manner that the time period for the transistor TR1 to turn off is relatively shorter at high temperatures and relatively longer at low temperatures. Therefore, the solenoid valve 13 may be closed relatively quickly when the surrounding temperature is high, and relatively slowly when the surrounding temperature is low so that the time duration of supplying the added amount of start fuel may be optimized for the given surrounding temperature.

Although it is preferred that the control of the solenoid valve 13 is based on both engine rotational speed as described in step ST2 and engine temperature as described in step ST3, it is also contemplated that the control may be based on either one individually. Accordingly, the hardware and control configurations may be simplified and manufacturing costs reduced.

FIGS. 4 and 5 illustrate another presently preferred form of an automatic fuel enrichment system, and related exemplary engine control circuit. This embodiment is similar in many respects to the embodiment of FIGS. 1 through 3 and like numerals between the embodiments generally designate like or corresponding elements throughout the several views of the drawing figures. FIG. 4 generally corresponds with FIG. 1 and FIG. 5 generally corresponds with FIG. 2. Additionally, the description of the common subject matter may generally not be repeated here.

The previously described relay RY and transistor TR2 are omitted and a positive terminal of the battery 23 is connected to a starter motor switch 26 for activating a starter motor 25. As shown in FIG. 4, the starter motor 25 is coupled to a crankshaft of the engine 1 in any suitable manner including but not limited to use of a centrifugal coupling, a stored-energy recoil-spring starter coupling, or the like. The starter motor switch 26 generally corresponds to the previously described starter switch 19, and is configured to be continually pressed or held down and thereby closed until the engine 1 starts and reaches an idling state.

As shown in FIG. 5, a downstream end or ground end of the starter motor switch 26 is connected to a first end of the coil of the solenoid valve 13. The other end of the coil of the solenoid valve 13 is connected to the collector of the switching device TR1. The resistive heater element 22 and the thermistor 21 are connected in circuit in a manner substantially similar to that as described previously.

This fuel enrichment start system for a carburetor of FIGS. 4 and 5, having the above described structure, functions substantially similarly to the previously described embodiment. Accordingly, step ST1 of the previously described method would be adapted such that when the starter motor switch 26 is turned ON the starter motor 25 cranks the engine 1 and, at substantially the same time, the battery voltage is applied to the solenoid valve 13 and the CPU 14a forwards an ignition signal to the ignition circuit 18 according to ignition timing based on the engine rotational signal obtained by the rotational sensor 15 for cranking the engine 1. But if the transistor TR1 is non-conductive (such as when the engine is warm), the coil of the solenoid valve 13 is not energized, and the solenoid valve 13 remains closed. In other words, the mode of controlling the solenoid valve 13 is also substantially similar to that of the previous embodiment. Thus, this embodiment eliminates the need for some component parts such as the relay RY and transistor TR2, wherein the circuit structure can be simplified and the manufacturing cost can be reduced.

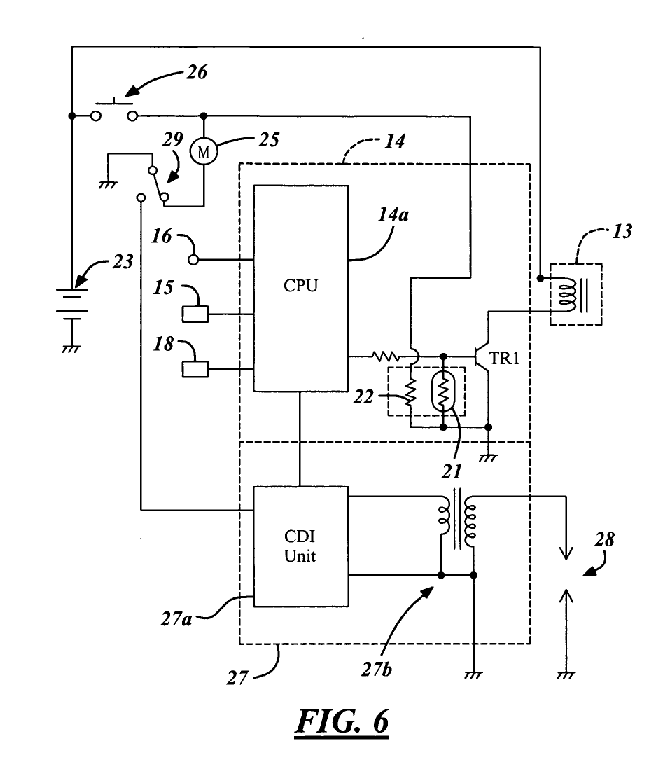

FIG. 6 illustrates another presently preferred form of an exemplary engine control circuit of an exemplary automatic fuel enrichment system such as that of FIG. 4. This form is similar in many respects to the forms of FIGS. 1 through 5 and like numerals between the forms generally designate like or corresponding elements throughout the several views of the drawing figures. FIG. 6 generally corresponds with FIGS. 2 and 5. Additionally, the description of the common subject matter may generally not be repeated here.

In the form of FIG. 6, the previously described relay RY and transistor TR2 are omitted and a positive terminal of the battery 23 is connected to the starter motor switch 26 for activating the starter motor 25. Here, however, a capacitive discharge ignition (CDI) circuit 27 includes a CDI device 27a connected to the processor 14a for powering the processor 14a, preferably via a rectifier device or diode (not shown).

CDI devices are widely used in spark-ignited internal combustion engines. As one example, CDI devices include a main capacitor (not shown), which during each cycle of the engine 1, is charged by an associated generator or charge coil (not shown) and is later discharged through a step-up transformer or ignition coil 27b to fire a spark plug 28. CDI devices typically have a stator assembly (not shown) including a ferromagnetic stator core (not shown) having wound thereabout the charge coil and the ignition coil 27b with its primary and secondary windings. A permanent magnet assembly (not shown) is typically mounted on an engine flywheel (not shown) to generate current pulses within the charge coil as the permanent magnet is rotated past the ferromagnetic stator core. The current pulses produced in the charge coil are used to charge the main capacitor which is subsequently discharged upon activation of a trigger signal. The trigger signal may be supplied by a trigger coil (not shown) that is also wound around the stator core, when the permanent magnet assembly cycles past the stator core to generate pulses within the trigger coil. Upon receipt of the trigger signal, the main capacitor discharges through the primary winding of the ignition coil 27b to induce a current in the secondary winding that is sufficient to cause a spark across a spark gap of the spark plug 28 to ignite a fuel and air mixture within a combustion chamber of the engine. Such CDI devices are generally known to those of ordinary skill in the art of engine ignition systems and any suitable CDI device may be used.

Additionally, an ignition switch 29 is connected to ground and to the CDI device 27a for preventing electric discharge across the spark plug gap when the ignition switch 29 is turned off so that the ignition coil 27b does not generate current in its secondary winding as the engine flywheel rotates. Also, an engine start switch such as the starter motor switch 26 is arranged in series between the battery 23 and the ignition switch 29 for grounding the electric starter motor 25 when the ignition switch 29 is turned on to enable current to flow through the motor 25 when the engine start switch 26 is activated.

Here, however, the coil of the solenoid valve 13 is not in a switched connection to the battery 23. Rather, the solenoid valve 13 is directly connected to the battery 23 and is only switched on and off by operation of the transistor TR1.

In operation, this fuel enrichment system functions according to the previously described method depicted in FIG. 3, but using starting switch circuitry different than the previously described embodiments.

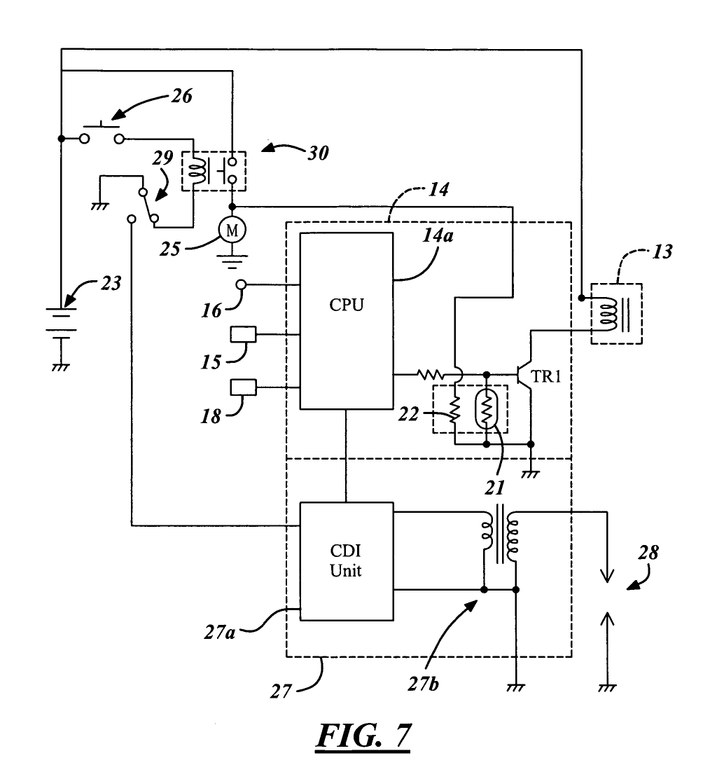

FIG. 7 illustrates a modification of the exemplary engine control circuit of FIG. 6. This form is similar in many respects to the form of FIGS. 1 through 6 and like numerals between the forms generally designate like or corresponding elements throughout the several views of the drawing figures. FIG. 7 generally corresponds with FIGS. 2, 5, and 6. Additionally, the description of the common subject matter may generally not be repeated here.

Here, the electric starter motor 25 is not directly connected to the engine start switch 26 as with the form of FIG. 6. Rather, a relay 30 is provided therebetween and has a coil arranged in series between the engine start switch 26 and the ignition switch 29 and has a contactor arranged in series between the battery 23 and the electric starter motor 25. The electric starter motor 25 is grounded and current flows through the motor 25 when the ignition switch 29 is turned on and the engine start switch 26 is closed.

Again, in operation, this fuel enrichment system functions according to the previously described method depicted in FIG. 3, but using starting switch circuitry somewhat different than the previously described forms.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components, elements, or items. Moreover, directional words such as top, bottom, upper, lower, radial, circumferential, axial, lateral, longitudinal, vertical, horizontal, and the like are employed by way of description and not limitation. Other terms are to be construed using their broadest reasonable meaning unless they are used in a context that requires a different interpretation. When introducing elements of the present invention or the embodiments thereof, the articles “a,” “an,” “the,” and “said” are intended to mean that there are one or more of the elements.

It is to be understood that the foregoing description is of one or more presently preferred embodiments of the invention. Accordingly, the invention is not limited to the particular exemplary embodiments disclosed herein, but rather is defined by the claims below. In other words, the statements contained in the foregoing description relate to particular exemplary embodiments and are not to be construed as limitations on the scope of the invention as claimed below or on the definition of terms used in the claims, except where a term or phrase is expressly defined above or where the statement specifically refers to “the invention.”

Although the present invention has been disclosed in conjunction with a limited number of presently preferred exemplary embodiments and forms, many others are possible and it is not intended herein to mention all of the possible equivalent embodiments, forms and ramifications of the present invention. Other modifications, variations, forms, ramifications, substitutions, and/or equivalents will become apparent or readily suggest themselves to persons of ordinary skill in the art in view of the foregoing description. In other words, the teachings of the present invention encompass many reasonable substitutions or equivalents of limitations recited in the following claims. As just one example, the disclosed structure, materials, sizes, shapes, and the like could be readily modified or substituted with other similar structure, materials, sizes, shapes, and the like. In another example, all of the various forms of the control circuitry and fuel enrichment systems described herein are hereby incorporated by reference into one another such that the various features and functionality of the various forms may be interchanged. Indeed, the present invention is intended to embrace all such embodiments, forms, ramifications, modifications, variations, substitutions, and/or equivalents as fall within the spirit and broad scope of the following claims.

What is claimed is:

1. A method of automatically enriching a fuel-and-air supply from a carburetor to a combustion engine, comprising:
(a) cranking the engine;
(b) providing fuel from a fuel chamber to a fuel-and-air mixing passage through a primary fuel supply passage;
(c) sensing at least one of engine speed or engine temperature;
(d) comparing the at least one of the sensed engine speed or engine temperature to one or more respective reference values;
(e) closing a supplementary fuel supply passage in communication between the fuel chamber and the fuel-and-air mixing passage, when the at least one of the engine speed or engine temperature are greater than or equal to the one or more respective reference values;
(f) opening the supplementary fuel supply passage when at least one of the engine speed or engine temperature are less than their respective reference values to enrich the fuel-and-air supply to the engine;
(g) sensing whether the engine speed is greater than or equal to an engine running reference value;
(h) repeating steps (a) through (f) if the engine speed is less than the engine running reference value;
(i) repeating steps (b) through (f) if the engine speed is greater than or equal to the engine running reference value;
(j) powering a heater element during engine cranking;
(k) sensing temperature adjacent the heater element; and
(l) closing the supplementary fuel supply passage when the temperature adjacent the heater element exceeds a prescribed level, regardless of whether at least one of the engine speed or engine temperature are greater than or equal to their respective reference values.

2. A fuel enrichment system for a combustion engine, comprising:
a supplementary fuel supply passage provided between a carburetor fuel chamber and fuel-and-air mixing passage;
a solenoid valve for opening and closing the supplementary fuel supply passage;
at least one engine sensor including at least one of an engine speed sensor for detecting a rotational speed of the engine or an engine temperature sensor for detecting a temperature of the engine;
a switching device connected in series with the solenoid valve for controlling the solenoid valve; and
engine control circuitry, including:
a processor that turns the switching device on or off in dependence on at least one of a temperature detected by the engine temperature sensor or a speed detected by the engine speed sensor;
a resistive heater element connected in parallel across the solenoid valve and switching device; and
a thermistor placed adjacent the resistive heater element and connected to a control line of the switching device so as to draw current from the control line to turn off the switching device when the resistive heater element rises in temperature beyond a prescribed level.

3. The fuel enrichment system of claim 2, further comprising:
a power source for supplying power to the solenoid valve; and
another switching device arranged in series between the power source and the solenoid valve.

4. The fuel enrichment system of claim 3, wherein the power source is a battery and the another switching device is a relay.

5. The fuel enrichment system of claim 4, further comprising a recoil starter for manually cranking the engine.

6. The fuel enrichment system of claim 3, wherein the power source is a battery for supplying power to the solenoid valve and the other switching device is an engine start switch.

7. The fuel enrichment system of claim 6, further comprising an electric starter motor arranged between the engine start switch and the solenoid valve for automatically cranking the engine.

8. The fuel enrichment system of claim 2, further comprising an ignition switch in communication with the processor, and wherein the engine control circuitry further includes a relay for controlling power to the solenoid valve and a switching device connected in series with the relay and controlled by the processor for controlling the relay in response to activation of the ignition switch.

9. The fuel enrichment system of claim 2, wherein the engine control circuitry also includes ignition control circuitry.

10. The fuel enrichment system of claim 2, wherein the processor, a resistive heater element, and thermistor are integrated into a module.

11. The fuel enrichment system of claim 2, wherein the at least one engine sensor includes both an engine speed sensor for detecting a rotational speed of the engine and an engine temperature sensor for detecting a temperature of the engine, and the processor controls the switching device to open the solenoid valve when either the rotational speed of the engine is below a predetermined speed value or the temperature of the engine is below a predetermined temperature value, and to close the solenoid valve when either the rotational speed of the engine is above the predetermined speed value or the temperature of the engine is above the predetermined temperature value.

12. The fuel enrichment system of claim 2, further comprising:
an electric starter motor for automatically cranking the engine;
a power source for supplying power to the electric starter motor and the solenoid valve; and
at least one other switching device arranged in series between the power source and the electric starter motor.

13. The fuel enrichment system of claim 12, wherein the power source is a battery and the at least one other switching device is an engine start switch.

14. The fuel enrichment system of claim 12, wherein the power source is a battery and the at least one other switching device is a relay.

15. The fuel enrichment system of claim 2, further comprising:
an electric starter motor for automatically cranking the engine;
a power source for supplying power to the electric starter motor and the solenoid valve;
a capacitive discharge ignition device connected to the processor for powering the processor;
an ignition switch connected to ground and to the capacitive discharge ignition device for grounding the capacitive discharge ignition device when the ignition switch is turned off; and
an engine start switch arranged in series between the power source and the ignition switch.

16. The fuel enrichment system of claim 15, wherein the electric starter motor is arranged in series between the engine start switch and the ignition switch for grounding the electric starter motor when the ignition switch is turned on to enable current to flow through the motor when the engine start switch is activated.

17. The fuel enrichment system of claim 15, further comprising a relay having a coil arranged in series between the engine start switch and the ignition switch and having a contactor arranged in series between the power source and the electric starter motor, wherein the electric starter motor is grounded and current flows therethrough when the ignition switch is turned on and the engine start switch is closed.

18. A combustion engine, comprising:
an engine cranking device for cranking the engine, including at least one of a manual recoil starter or an electric starter motor;
a carburetor including:
a fuel chamber;
a fuel-and-air mixing passage;
a primary fuel supply passage between the fuel chamber and the fuel-and-air mixing passage; and
a supplementary fuel supply passage between the fuel chamber and the fuel-and-air mixing passage;
a solenoid valve for opening and closing the supplementary fuel supply passage;
at least one engine sensor including at least one of an engine speed sensor for detecting a rotational speed of the engine or an engine temperature sensor for detecting a temperature of the engine;
a switching device connected in series with the solenoid valve for controlling the valve; and
engine control circuitry, including:
a processor that turns the switching device on or off in dependence on at least one of a temperature detected by the temperature sensor or a speed detected by the engine speed sensor;
a resistive heater element connected in parallel across the solenoid valve and switching device; and
a thermistor placed adjacent the resistive heater element and connected to a control line of the switching device so as to draw current from the control line to turn off the switching device when the resistive heater element rises in temperature beyond a prescribed level.

19. The combustion engine of claim 18, further comprising an ignition switch in communication with the processor, and wherein the engine control circuitry further includes a relay connected to the battery for controlling power to the solenoid valve and a switching device connected in series with the relay and controlled by the processor for controlling the relay in response to activation of the ignition switch.

20. The combustion engine of claim 18, further comprising
a battery for supplying power to the solenoid valve; and
an engine start switch arranged in series between the battery and the solenoid valve
an electric starter motor arranged between the engine start switch and the solenoid valve for automatically cranking the engine.

21. The combustion engine of claim 18, further comprising:
an electric starter motor for automatically cranking the engine;
a power source for supplying power to the electric starter motor and the solenoid valve;
a capacitive discharge ignition device connected to the processor for powering the processor;
an ignition switch connected to ground and to the capacitive discharge ignition device for grounding the capacitive discharge ignition device when the ignition switch is turned off; and
an engine start switch arranged in series between the power source and the ignition switch.
